(19) United States
(12) Patent Application Publication
(10) Pub. No.: US 2006/0049609 A1
(43) Pub. Date: Mar. 9, 2006

(54) Scooter-bike

(76) Inventors: Kenneth Andrew Sicz, Gilbert, AZ (US); Allan Charles Sicz, Lewistown, MT (US); Michael Andrew Sicz, Mesa, AZ (US)

Correspondence Address: KENNETH ANDREW SICZ, 490 SOUTH ROANOKE STREET, GILBERT, AZ, 85296, US

(21) Appl. No.: 10/934,935

(22) Filed: Sep. 8, 2004

(51) Int. Cl. B62M 1/02

(52) U.S. Cl. 280/261

(57) ABSTRACT

A low center of gravity scooter using a standard bicycle pedal system for initial forward motion. The front wheel of the scooter is pivotally mounted to a frame and includes an upwardly extended shaft supporting a chopper style handlebar, for steering. A rear wheel pedal system including a pedal crank, sprocket, and chain drive, mounted to the scooter frame. The rear wheel assembly includes a sprocket with free wheeling chain drive hub for forward motion and free wheel coasting. This unique Scooter-Bike uses a bicycle pedal system to provide forward motion on a stand-up scooter vehicle that can be ridden as a bicycle until sufficient speed is attained. The rider then can maneuver it in the stand-up position as a very maneuverable scooter.

### BACKGROUND OF THE INVENTION

### FIELD OF THE INVENTION

The Scooter-Bike design relates to scooters and, more particularly to a unique scooter design using a efficient bike pedal system for sustained forward motion along with stand-up scooter action, motion and maneuverability. Conventional scooters are propelled forwardly by a rider having one foot on a platform between the front and rear wheels and pushing rearwardly against the ground with the other foot. Such scooters are speed limited on a flat surface by the speed and power of the rider pushing rearwardly against the ground. Because of the physical effort required, scooters of this type are relatively slow and higher speeds are possible only for short periods of time.

To increase the sustainable duration at higher speed, various foot operated motive mechanisms have been developed. One type of mechanism includes a foot operated lever repetitively drawing a chain in contact with a sprocket secured to the rear wheel through a one way clutch. In another type of self propelled scooter, a pair of footpads or pegs are pumped by the rider's feet, which pumping motion is translated to rotary motion of the rear wheel. These mechanisms overcome the need to repeatedly push against the ground with one of the rider's feet but various detrimental aspects exist. For example, the resulting speed of the scooter is little more, if any, beyond that of a conventional scooter wherein the same amount of effort is applied. The rear mounted pedal system on the scooter-bike allows the rider to accelerate the scooter quickly through efficient foot pedal action along with foot operated motion. Sustained motion on flat surfaces or inclined surfaces are also available using the pedal system.

### SUMMARY OF THE INVENTION

The market today is filled with many varieties of conventional and specialized scooters and bicycles. Motion mechanisms range from use of your leg to gas and electric engines for scooters and a variety of pedal and gear mechanisms for bicycles.

The Scooter-Bike design integrates the quick motion of a small platform scooter with the upright pedal action motion of a bicycle. The rider is able to use the pedal action for starting motion or sustaining motion up an incline and then stand-up using the vehicle as a fluid fast motion scooter. The scooter-bike design includes a seat an pedal system mounted rearward to provide positive pedal action over the real wheel and allow the rider to easily stand-up for scooter action. Likewise the handle bar design includes a chopper design with longer neck for good control for stand-up scooter action. The scooter-bike design provides a very fast, fluid, and acrobatic scooter with a upright and efficient bicycle pedal action for sustained forward motion.

It is therefore a primary object of the present invention to provide the option of both foot to ground operated motion and pedal operated motion.

Another object of the present invention is to provide efficient rearwardly mounted pedal mechanism for propelling and accelerating the scooter.

Yet another object of the present invention is to provide a low center of gravity scooter design that enables stable high speed maneuvers.

Still another object of the present invention it to provide a wider scooter platform that allows the rider to stability and maneuverability in the stand-up position.

A further object of the present invention is to provide a unique chopper handlebar design with longer neck for enhanced stand-up operation and scooter action.

A yet further object of the present invention is to provide an quick stop action braking system using front and rear caliper brakes.

### BRIEF DESCRIPTION OF THE PHOTOS AND DRAWINGS

The scooter-bike invention may be described with greater specificity and clarity with reference to FIG. 1-5 Photos and Drawings 1-3.

FIG. 1 provides a side view of the scooter-bike;

FIG. 2 provides a side view of the scooter-bike without the platform base attached;

FIG. 3 provides the opposite side view of the scooter-bike as in FIG. 1;

FIG. 4 provides as side view of the scooter-bike, with key design features;

FIG. 5 provides a top view of the scooter-bike handlebars and safety pads;

Drawing 1 is a mechanical drawing of the overall Scooter-Bike;

Drawing 2 is a mechanical drawing of the platform frame and steering extender (side view);

Drawing 3 is a mechanical drawing of the platform frame and platform (top view)

### DESCRIPTION OF THE PREFERRED EMBODIMENT

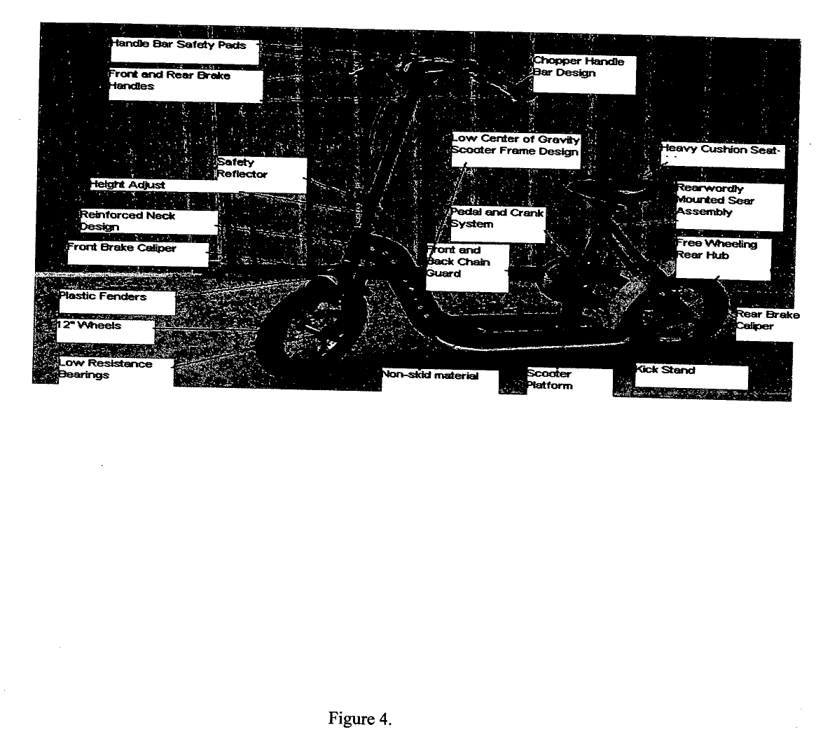

Referring to FIG. 4, there is shown a perspective view of the Scooter-Bike embodying the present invention. A chopper handle bar design with safety pads, front and rear brake handles, safety reflector, reinforced neck design, front and rear caliper brakes, plastic fenders, 12 inch wheels, low resistance bearings, low center of gravity scooter frame design, front and back chain guard, heavy cushion seat, rearwardly mounted seat assembly, free wheeling rear hub, kick stand, custom low center of gravity scooter frame design with stand-up platform with non-skid material.

Drawing 1, provides an overall Scooter-Bike mechanical drawing, showing the unique design features, that include, customer chopper handle bar design, extended handle bar neck for upright scooter operation, large 12 inch pneumatic wheels with precision bearings, custom frame and platform design with double tubing reinforced neck and large stand-up platform, rearwardly mounted reinforced 4.5″ pedal crank set with 2″ ID rotated 10.5 degrees from verticle, 15 degree offset rear wheel frame mount, single speed free wheeling rear hub assembly and front and rear 3″ reach brake pad arm caliper braking system for quick stopping action.

Drawing 2, provides a detailed platform frame and steering extender tube mechanical drawing (side view), showing the following unique design features: Steel wall extender tube with solid steel anti-crush rod spot welded to the front fork tube. Double steel tubing neck design with steel web for additional radius mathematically dimensioned to keep tubes parallel. All electrically welded frame design. Pedal assembly using 1″ by 2″ oval tubing welded to crank assembly and frame. Seat neck rotated 10.5 degrees rearwardly using two steel tubing extenders welded to the rear fork assembly. 15 degree vertically rotated rear fork to provide low center of gravity frame and platform design.

Drawing 3, provides a detailed platform frame and platform mechanical drawing (top view), showing the following unique design features: 10 inch wide stand-up platform for stand-up operation from the front and rear of the platform. Wrap around base plate of formed aluminum or plastic attached with rivets or adhesive bonding. Anti-skid tape on platform. Flat bar stock 0.125″ thick inserted and tig welded to rear fork tube for rear fork wheel mount.

We claim:

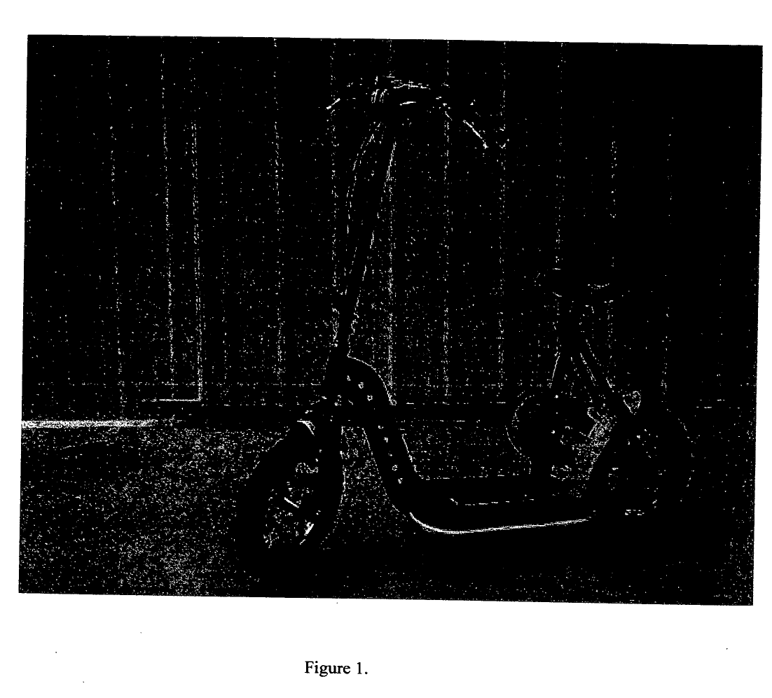

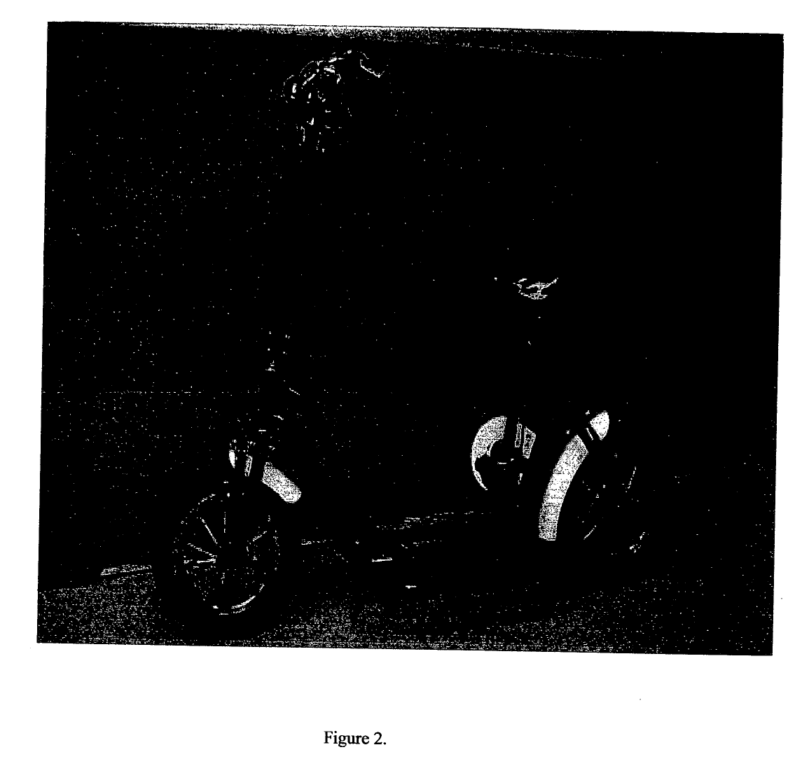

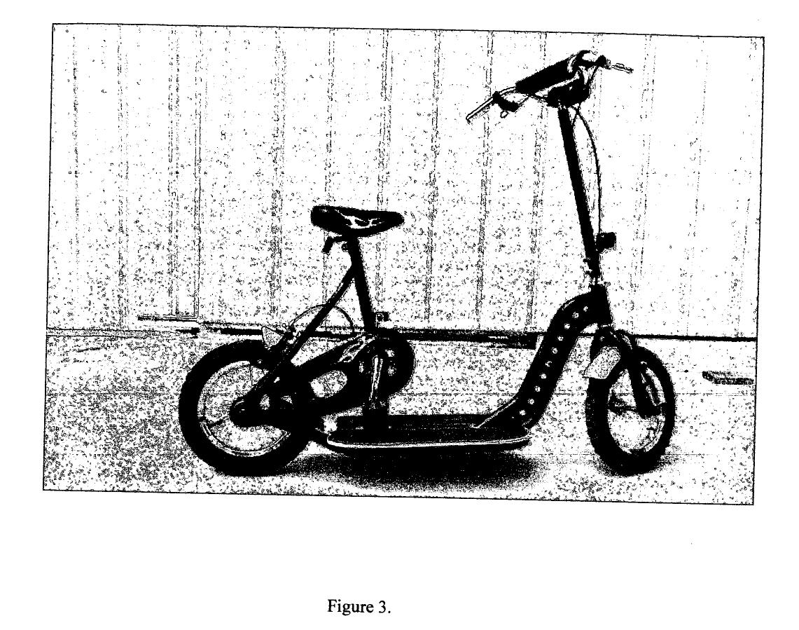

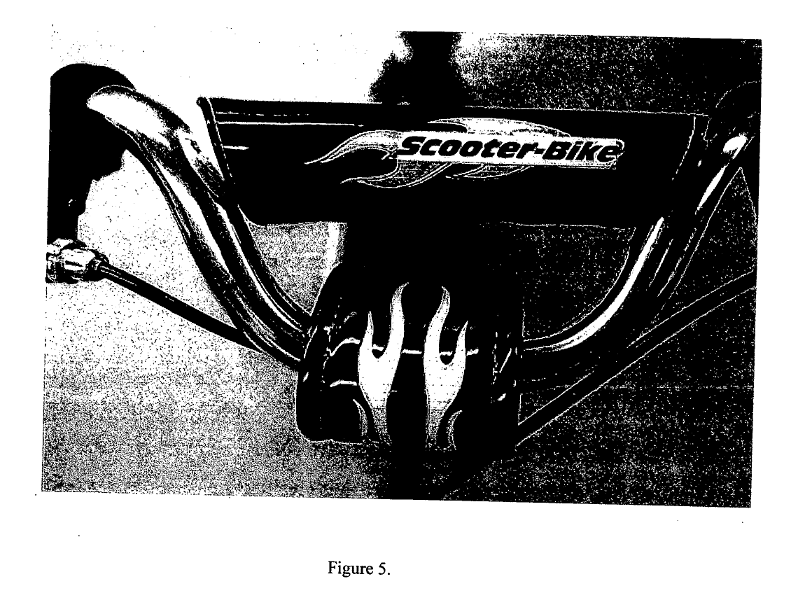

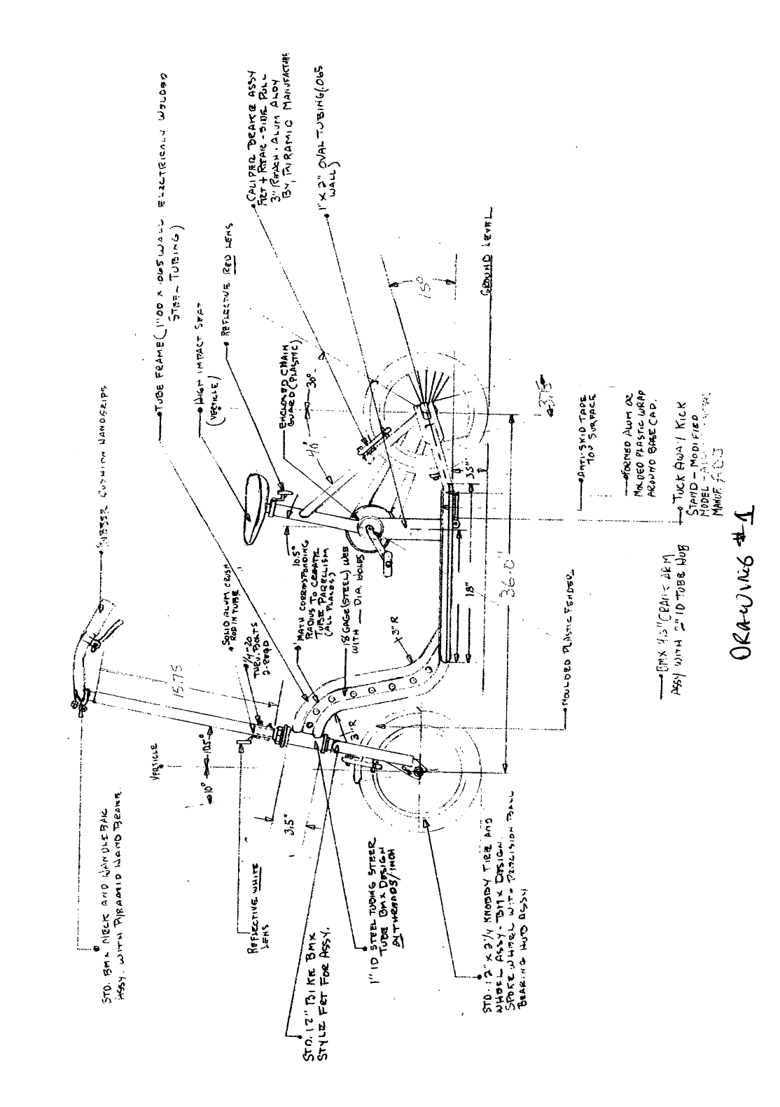

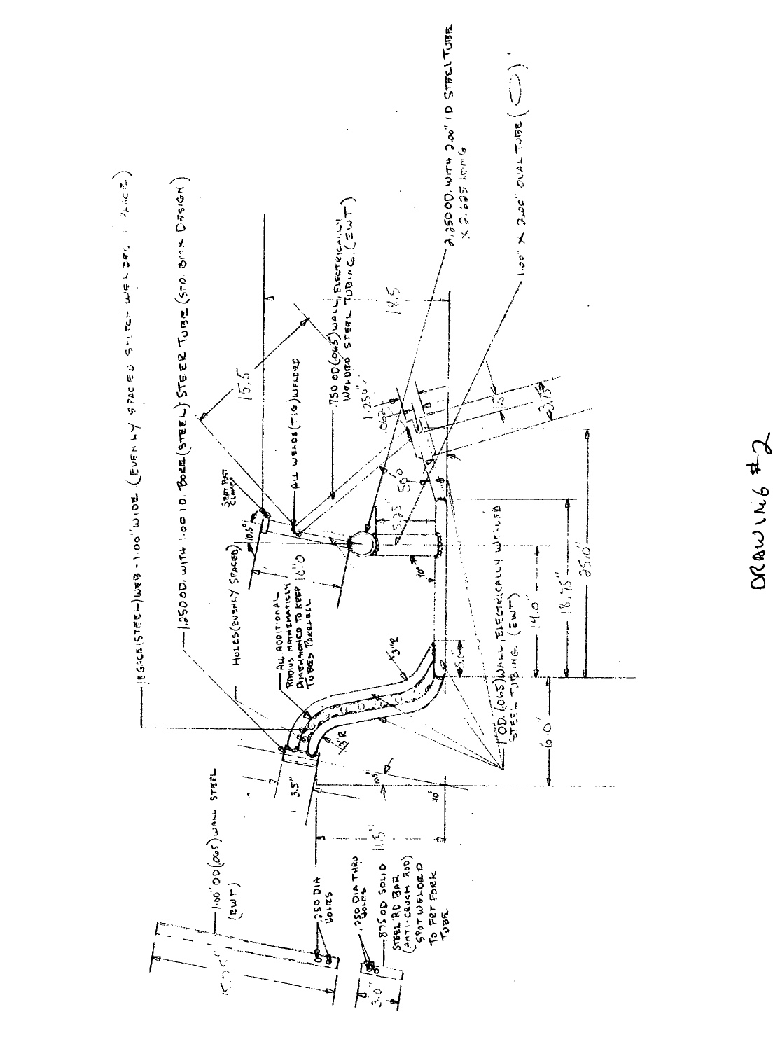

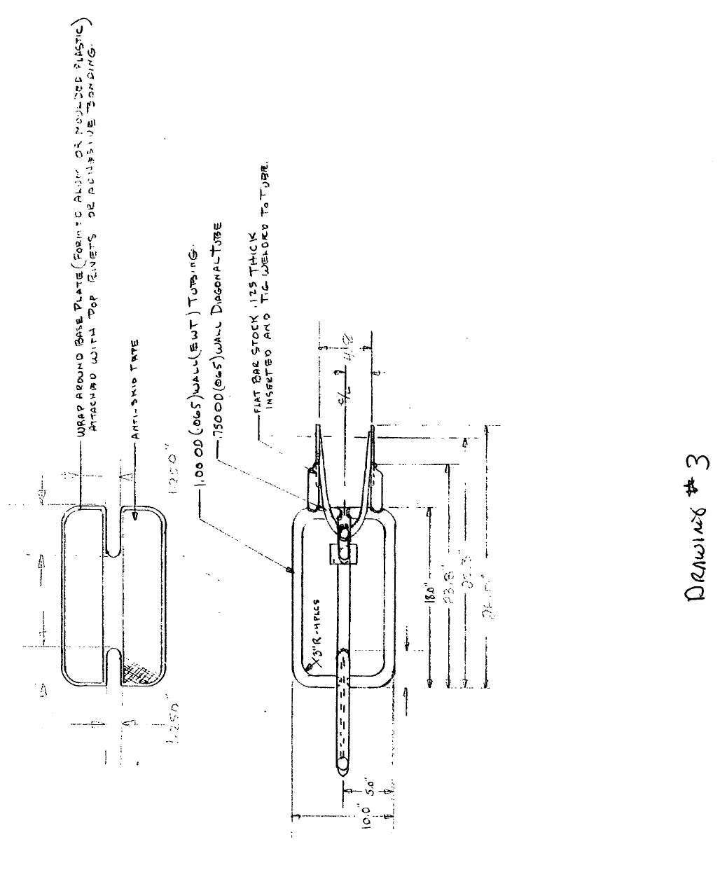

1. A Scooter-Bike, compromising in combination:
a. A scooter frame assembly having a large flat standing platform for upright drive capability, a front fork assembly, and rear frame extenders, supporting the rear wheel assembly. Refer to FIGS. 1-5.
b. A bike pedal system mounted rearward on the scooter frame, consisting of left and right pedals and cranks, with chain sprocket.
c. A front bike seat mounted 10 degrees rearward of vertical above the pedal system, with an adjustable height provision.
d. A front wheel and steering system, that includes an extender tube connecting the chopper style handle bars to the lower wheel fork.
e. A rear wheel system consisting of a drive chain sprocket, free wheeling hub, mounted to the rear scooter frame extenders.
f. A front and rear caliper braking system with braking control levers mounted on the left and right ends of the handle bars.

2. A Scooter-Bike, comprising of the following combination of design features:
a. A frame design constructed of electrically welded steel tubing for strength and weight stability. Refer to FIGS. 1-3.
b. A frame design with a twin tubing neck, encompassing a sheet steel center web, connecting the steering (head set tube) to the base frame, for strength and stability.
c. A low center of gravity rounded rectangular platform base constructed of steel tubing, connected to the neck from three points (center, left, right) and the rear frame extenders.
d. The platform base is constructed of sheet aluminum or plastic and is attached to the top of the tubular steel frame. The platform provides a large surface to operate the vehicle from.
e. The large wide base platform also enables the operator to apply downward pressure at rear or front, left or right, for fast and unique scooter maneuverability and tricks.
f. A twelve inch front and rear wheel with high speed steel bearings and pneumatic tires, steel spokes and wheels, provide for low rolling resistance and high speed.
g. A front fork and handlebar design consisting of a long handle bar extender tube for operation when standing, chopper style handle bars for a unique feel and amplified steering operation while standing or sitting.
h. A high compression seat with adjustable height provisions mounted slightly rearward of the pedal assembly, toward the rear wheel, to allow the operator's body weight to be over the rear wheel, thus enabling the operator to more easily lift the front wheel for scooter tricks. The seat is mounted on a strong steel tubular shaft with stabilizer bars welded to the rear frame assembly.
i. A pedal, crank and drive sprocket mechanism mounted directly to the scooter base frame.
j. A free wheeling rear sprocket is used for very low rolling resistance.
k. A front and rear caliper breaking system is used with left and right hand grips mounted to the handle bar, thus providing an efficient breaking system.
l. A single action kick stand is used, mounted under the left side of the scooter platform for vertical support when parked. This stand easily tucks away neatly under the base platform when the scooter is ridden for ease of operation and safety.
